(19) United States
(12) Patent Application Publication
(10) Pub. No.: US 2014/0169612 A1
(43) Pub. Date: Jun. 19, 2014

(54) MULTIFUNCTION MOUTH MASK

(71) Applicant: Michael Shih, CHANGHUA COUNTY (TW)

(72) Inventor: Michael Shih, CHANGHUA COUNTY (TW)

(21) Appl. No.: 13/716,190

(22) Filed: Dec. 16, 2012

(51) Int. Cl. H04R 1/02

(52) U.S. Cl. CPC H04R 1/025
USPC 381/388

(57) ABSTRACT

A multifunction mouth mask includes a mask body having two elastic cords respectively connected with two lateral ends of the mask body. A receiving space is opened on one side surface of the mask body. A sounding unit is received in the receiving space of the mask body. The sounding unit has a filter placed into the receiving space. A connecting unit is connected between the sounding unit and the receiving space for positioning the sounding unit into the receiving space of the mask body. Wherein, when a user wears the mouth mask for covering the mouth and the nose thereof, the user can control the sounding unit to sound a voice.

### BACKGROUND OF THE INVENTION

1. Field of the Invention

The present invention relates to a mouth mask, and more particularly to a multifunction mouth mask.

2. Description of Related Art

Because the air pollution is more and more serious, many people wear a mouth mask for blocking the dust or the bacteria from floating into their body. Regardless of driving, commuting or staying in an airtight space, people wear the mouth mask for avoiding breathing the suspended dust or bacteria into their body. Additional, a biker or a motorcycle rider usually wears the mouth mask for blocking the sandy wind, dust or the polluted vehicle exhaust filled in the air from increasing a bad influence to his body.

In order to control the traffic order, a police or a volunteer usually sounds a whistle, and gestures via a baton for introducing many vehicle drivers to pass the crowded roadway. However, when the vehicle driver stop their vehicle at a stop line, a gas of the vehicle will not be burned entirely and will form a polluted exhaust, so that an exhaust system of the vehicle will release the polluted exhaust into the air. Therefore, because the police or the volunteer needs to use the whistle to control the traffic order, the police or the volunteer cannot wear the mouth mask, so that the police or the volunteer would breathe the polluted exhaust and further damage his health.

Furthermore, in a hospital, a laboratory or a clean room, many workers need to wear the mouth mask for avoiding breathing the toxic air or the bacteria into their body. However, when the workers talk in the said hospital, the laboratory or the clean room, they cannot clearly listen to each other because the mouth mask blocks a transportation of a talk voice from the workers, and the volume of the talk voice from the workers is decreased. Therefore, the workers cannot efficiently confirm what they talk between each other.

The present invention has arisen to mitigate and/or obviate the disadvantages of the conventional.

### SUMMARY OF THE INVENTION

The main objective of the present invention is to provide an improved mouth mask.

To achieve the objective, a multifunction mouth mask includes a mask body having two elastic cords respectively connected with two lateral ends of the mask body. A receiving space is opened on one side surface of the mask body. A sounding unit is received in the receiving space of the mask body. The sounding unit has a filter placed into the receiving space. A connecting unit is connected between the sounding unit and the receiving space for positioning the sounding unit into the receiving space of the mask body. The connecting unit is connected with one side of the sounding unit and is placed into the receiving space. The connecting unit has two velcro straps respectively combined with the filter and one bottom wall of the receiving space. The two velcro straps can be stuck to each other repeatedly. An embodiment shows that the sounding unit has a whistle connected with the sounding unit. Another embodiment shows that the sounding unit further comprises a speaker received in the receiving space, a processing unit electrical connected with the speaker, a power supply electrical connected with the processing unit and a microphone erectrical connected with the processing unit.

Wherein, when a user wears the mouth mask for covering the mouth and the nose thereof, the user can control the sounding unit to sound a voice.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a first embodiment of a multifunction mouth mask of the present invention;

FIG. 2 is a perspective view of the first embodiment of the present invention;

FIG. 3 is a cross-sectional view of the first embodiment of the present invention, for showing that a user wears the multifunction mouth mask and sounds a whistle;

FIG. 4 is a perspective view of a second embodiment of the present invention;

FIG. 5 is a block chart of the second embodiment of the present invention, for showing a relationship between a speaker, a processing unit, a power supply and a microphone; and

FIG. 6 is a cross-sectional view of the second embodiment of the present invention, for showing that a user wears the multifunction mouth mask and sounds a speaker.

### DETAILED DESCRIPTION OF THE INVENTION

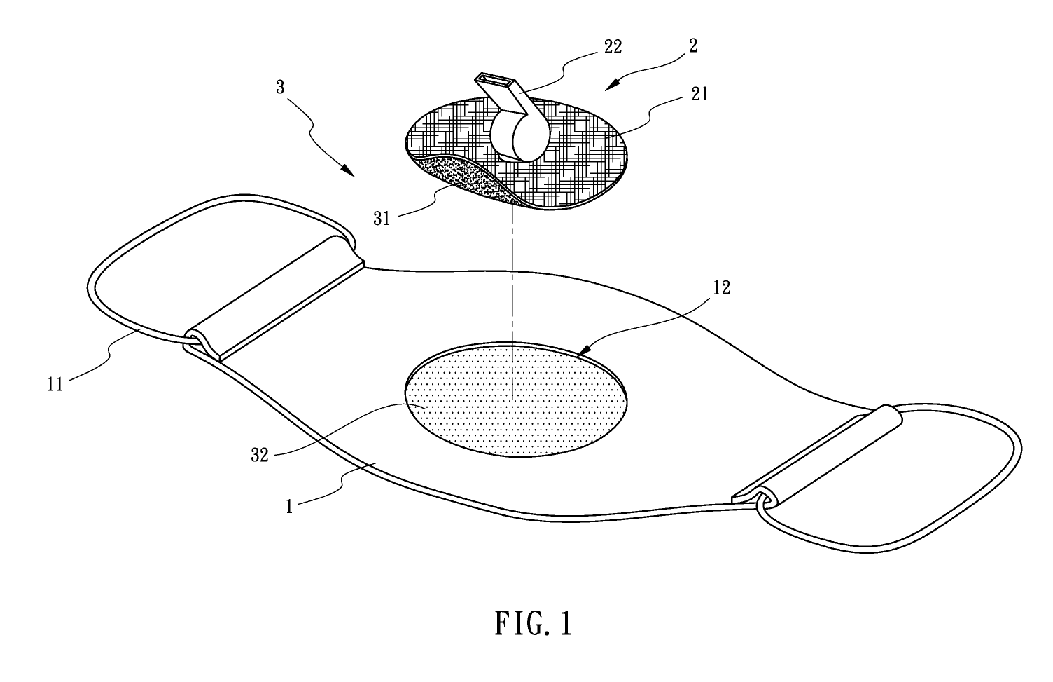

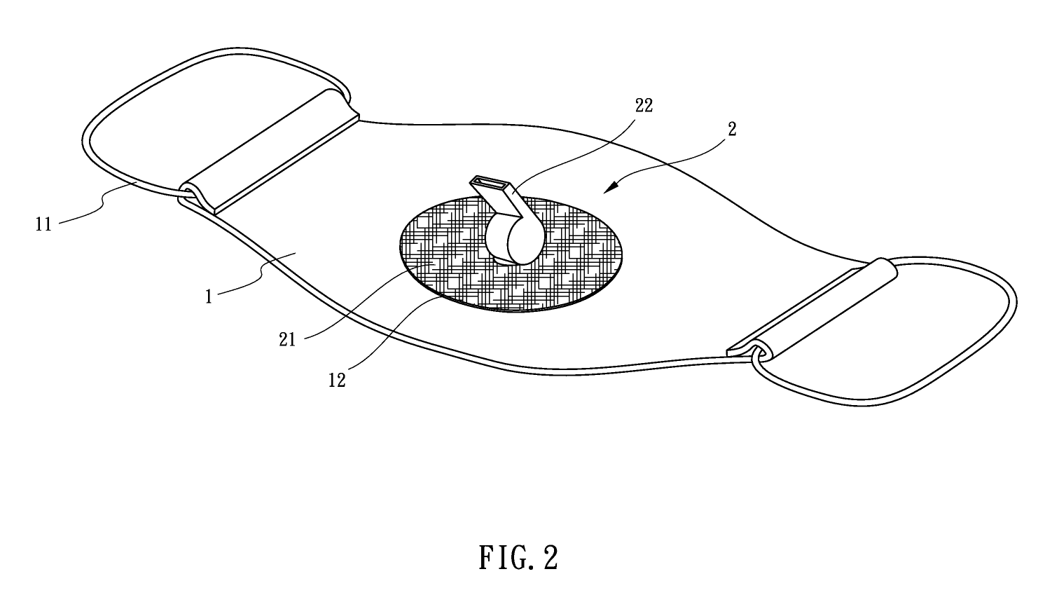

Referring to the drawings to FIGS. 1-2, a first embodiment of the present invention shows a multifunction mouth mask, which comprises a mask body 1 having two elastic cords 11 respectively connected with two lateral ends of the mask body 1. The mask body 1 comprises a plurality of filter cloths which are stacked up. A receiving space 12 is opened on a central portion of one side surface of the mask body 1 and is formed as circle-shaped. A user can use the two elastic cords 11 to hitch on two ears thereof. Thus, the mask body 1 can cover the nose and mouth of the user for blocking the air pollutant and the dust of the outer space.

A sounding unit 2 is received in the receiving space 12 of the mask body 1. The sounding unit 2 has a filter 21 assembled into the receiving space 12. The sounding unit 2 has a whistle 22 connected with the sounding unit 2 (The first embodiment shows that the whistle 22 is connected with the filter 21, so that the sounding unit 2 is surrounded by the filter 21).

A connecting unit 3 is connected between the sounding unit 2 and the receiving space 12 for positioning the sounding unit 2 into the receiving space 12 of the mask body 1. The connecting unit 3 is connected with one side of the sounding unit 2 and is placed into the receiving space 12 (As the above description, the whistle 22 of the sounding unit 2 is connected with the filter 21). The connecting unit 3 has two velcro straps 31, 32 respectively combined with the filter 21 of the sounding unit 2 and one bottom wall of the receiving space 12. The two velcro straps 31, 32 can be stuck to each other repeatedly for positioning the sounding unit 2 into the receiving space 12 of the mask body 1.

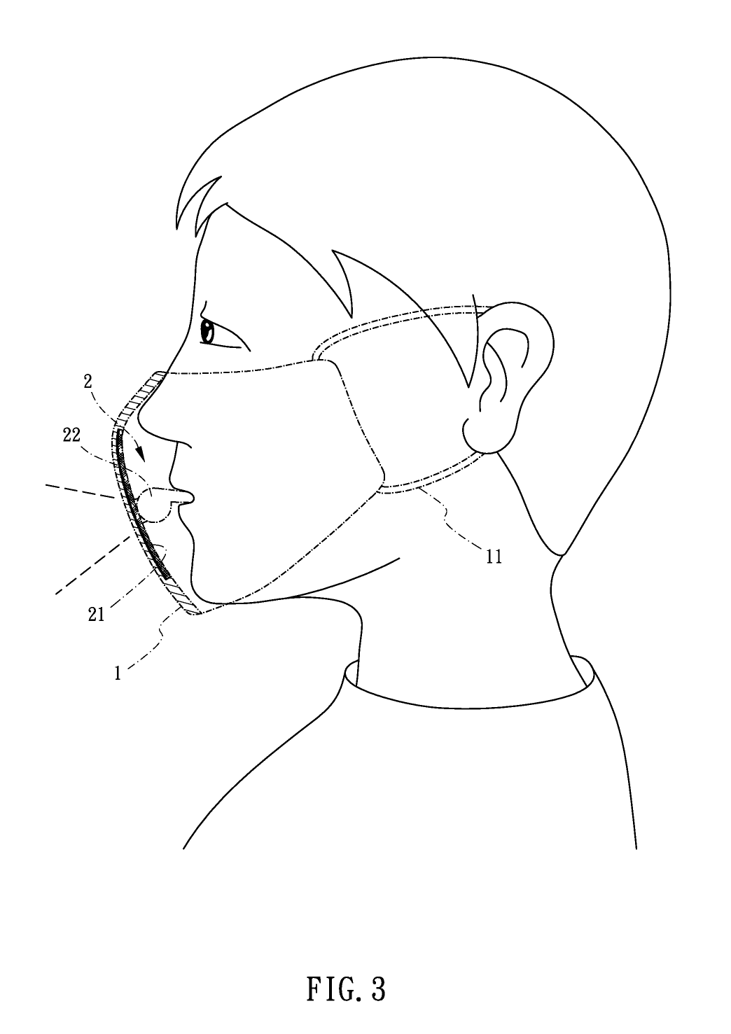

Referring to the drawings to FIGS. 2-3, the first embodiment shows when the user wears the present invention, the filter 21 of the mask body 1 can filter a plurality of polluted matters of the outer space for blocking micro dusts or bacteria floated in the air. Under the above arrangement, a police or a volunteer can wear the present invention and control the whistle 22 directly to sound the whistle 22 without taking off the mask body 1. Therefore, the police or the volunteer can stand in a polluted environment safely to control the traffic order via the whistle 22 and gestures via a baton.

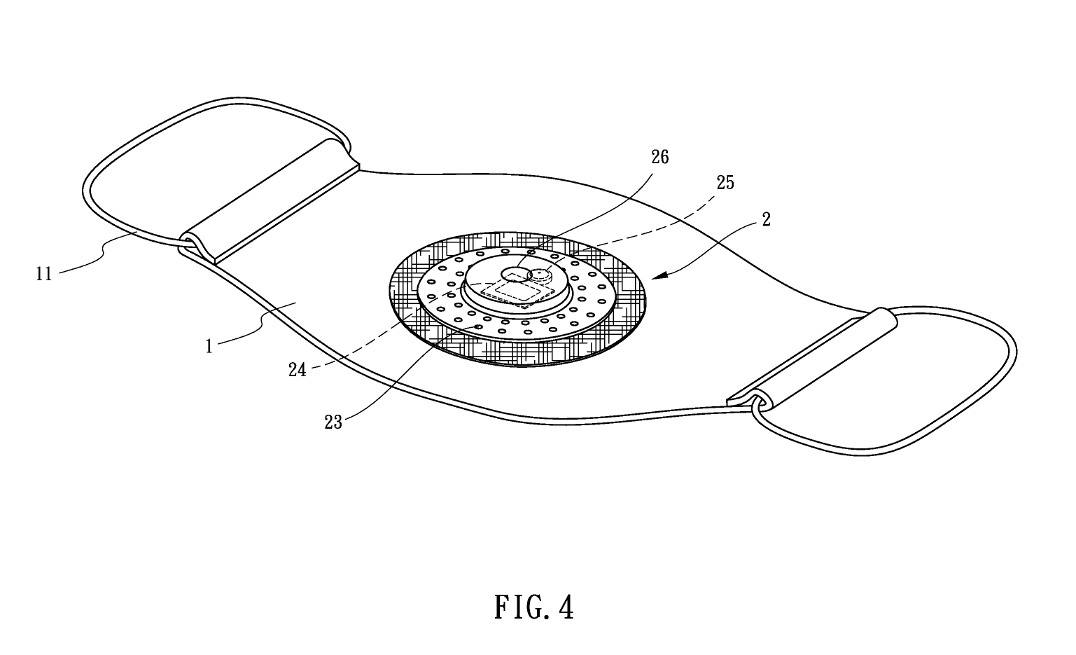

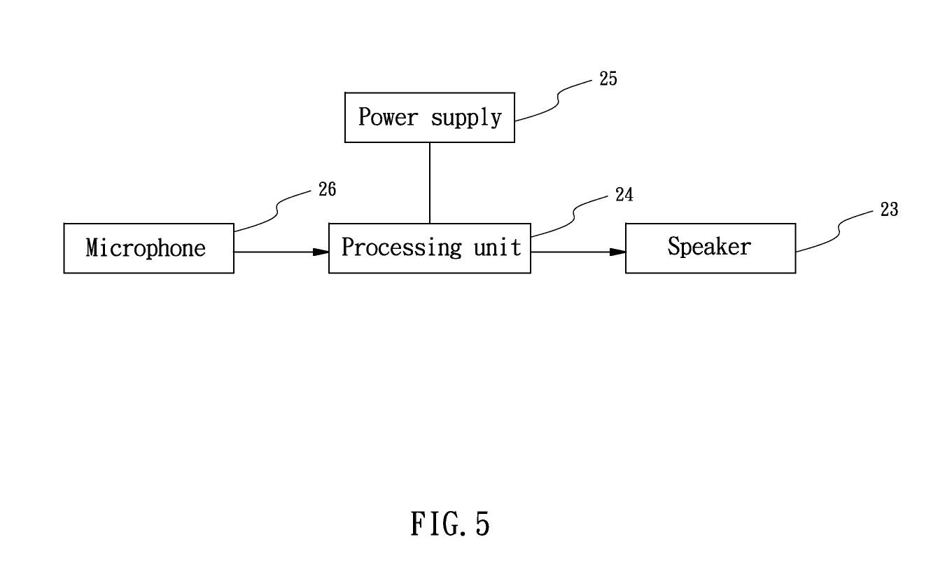

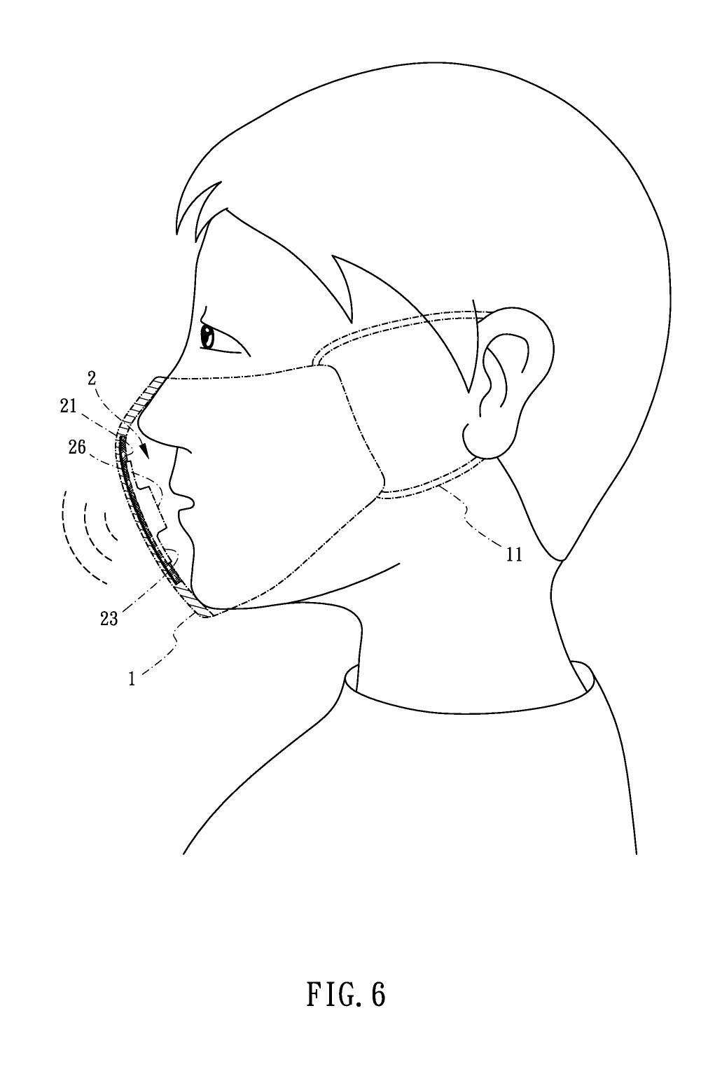

Additional, referring to the drawings to FIGS. 4-6, a second embodiment of the present invention shows that the sounding unit 2 further comprises a speaker 23 received in the receiving space 12, a processing unit 24 electrically connected with the speaker 23, a power supply 25 electrically connected with the processing unit 24 and a microphone 26 electrically connected with the processing unit 24 (The second embodiment shows that the power supply 25 is a battery for providing a electric power to the processing unit 24, the microphone 26 and the speaker 23).

Under the above arrangement, when the user wears the present invention and sounds a voice, the microphone 26 receives the voice and transports the voice to the processing unit 24; and then, the processing unit 24 transforms the voice into an amplified voice; as a result, the speaker 23 releases the amplified voice toward the outer space. Therefore, the user can talk clearly and loudly in a hospital, a laboratory or a clean room for communicating with other people exactly.

Although the invention has been explained in relation to its preferred embodiment, it is to be understood that many other possible modifications and variations can be made without departing from the spirit and scope of the invention as hereinafter claimed.

What is claimed is:

1. A multifunction mouth mask comprising:
a mask body having two elastic cords respectively connected with two lateral ends thereof, a receiving space opened on one side surface of the mask body;
a sounding unit received in the receiving space of the mask body, the sounding unit having a filter placed into the receiving space; and
a connecting unit connected between the sounding unit and the receiving space for positioning the sounding unit into the receiving space of the mask body;
wherein, when a user wears the mouth mask for covering the mouth and the nose thereof, the user can control the sounding unit to sound a voice.

2. The multifunction mouth mask as claimed in claim 1, wherein the connecting unit is connected between one side of the sounding unit and the receiving space; the connecting unit has two velcro straps respectively combined with the filter and one bottom wall of the receiving space, the two velcro straps can be stuck to each other repeatedly.

3. The multifunction mouth mask as claimed in claim 1, wherein the sounding unit has a whistle connected with the sounding unit.

4. The multifunction mouth mask as claimed in claim 1, wherein the sounding unit further comprises a speaker received in the receiving space, a processing unit electrically connected with the speaker, a power supply electrically connected with the processing unit and a microphone electrically connected with the processing unit.
